(19) United States
(12) Patent Application Publication
(10) Pub. No.: US 2025/0202411 A1
(43) Pub. Date: Jun. 19, 2025

(54) WIND TOLERANT SOLAR TRACKER

(71) Applicant: Nextracker LLC, Fremont, CA (US)

(72) Inventors: Tushar Guha, Milpitas, CA (US); Jacob Mark Morin, Phoenix, AZ (US); Abhimanyu Sable, Manikonda (IN); David Kresse, Walnut Creek, CA (US); Asher Dakarapu, Lingampally (IN)

(21) Appl. No.: 18/541,131

(22) Filed: Dec. 15, 2023

(51) Int. Cl. H02S 20/32; H02S 40/00

(52) U.S. Cl. CPC H02S 20/32; H02S 40/00

(57) ABSTRACT

A solar module tracking apparatus includes a solar module, a wind distribution panel, and a torque tube. The solar module has a first side that includes a plurality of photovoltaic cells and a second, opposite side. The solar module has a solar module length and solar module width, with the solar module length and the solar module width laying in a first plane. The wind distribution panel is spaced apart from the second side of the solar module to define a plenum between the wind distribution panel and the second side of the solar module. The wind distribution panel has a wind distribution panel length and wind distribution panel width, with the wind distribution panel length and the wind distribution panel width laying in a second plane that is different than the first plane. The torque tube is configured to rotatably move the solar module and wind distribution panel.

### TECHNICAL FIELD

This disclosure relates generally to device, system, and method embodiments for a wind tolerant solar tracker and related components. Embodiments disclosed herein can be configured to help reduce a magnitude of wind loading applied at a solar tracker and thereby help to increase the useful life and potential geographic installation locations for solar energy generation.

### BACKGROUND

Solar modules can convert sunlight into energy. Solar tracking systems can support a plurality of solar modules and function to rotate these solar panels amongst a variety of different orientations throughout a given day to optimize a solar irradiance angle and, thereby, optimize energy generation from the solar modules.

When installed in the field, solar tracking systems can experience a variety of dynamic loads. As one example, solar tracking systems can be exposed to dynamic wind loads in the field. The magnitude of such wind loads can depend on the orientation of the solar modules at the time of wind loading. And without an appropriate mechanism to help alleviate relatively high magnitude wind loading, solar tracking systems and the associated solar modules can be damaged. One possible solution to alleviate dynamic wind loading is to reorient the solar modules at the tracker to reduce the magnitude of wind loading on the solar modules. But reorienting the solar modules at the tracker can result in the solar modules being moved out of the intended, optimized energy generation position at that time and yet for helping to alleviate what can be a temporary, dynamic degree of wind loading.

### SUMMARY

This disclosure in general describes embodiments of devices, systems, and methods for helping to reduce a magnitude of wind loading applied at a solar tracker and associated solar modules. Embodiments disclosed herein can be configured to facilitate a net reduction in wind loading at a solar module, for instance, by incorporating one or more components that can reduce at least one of a positive wind load pressure and a negative wind load pressure on a solar module to thereby help to reduce the overall magnitude of wind load pressure at the solar module. As such, embodiments disclosed herein can help to increase the useful life and potential installation locations for solar energy generation. Moreover, embodiments disclosed herein can facilitate more common usage of weather-induced stowing of solar modules which can lead to increased solar module durability and cost savings. For example, relatively high wind loads can oftentimes be experienced at a solar module at a same time as other detrimental weather condition(s), and certain of these other detrimental weather conditions, such as hail, can warrant rotating the solar modules to a stowed position. Yet the stowed position of the solar modules can result in increasing the overall magnitude of wind load pressure at a solar module, leaving the solar modules at risk to wind damage in an effort to prevent hail damage. Embodiments disclosed herein can be configured to reduce the magnitude of wind loading at one or more solar modules, for instance when in the weather-induced stowed position, and thereby help to facilitate more robust and common usage of weather-induced stowing.

One embodiment includes a solar module tracking apparatus. This solar module tracking apparatus includes a solar module, a wind distribution panel, and a torque tube. The solar module has a first side that includes a plurality of photovoltaic cells and a second side that is opposite the first side. The solar module has a solar module length and a solar module width, with the solar module length and the solar module width laying in a first plane. The wind distribution panel is spaced apart from the second side of the solar module to define a plenum between the wind distribution panel and the second side of the solar module. The wind distribution panel has a wind distribution panel length and a wind distribution panel width, with the wind distribution panel length and the wind distribution panel width laying in a second plane that is different than the first plane. The torque tube is configured to rotatably move the solar module and the wind distribution panel.

In a further embodiment of this apparatus, the first plane is parallel to the second plane at all rotational positions of the torque tube. The wind distribution panel length can be equal to or greater than the solar module length and/or the wind distribution panel width can be equal to or greater than the solar module width. In one example, the wind distribution panel defines a wind distribution panel interior area that is bounded by the wind distribution panel length and the wind distribution panel width, and the wind distribution panel interior area is non-porous.

In a further embodiment of this apparatus, the wind distribution panel is configured to direct wind into the plenum to reduce a magnitude of a wind-induced pressure load at the solar module. In one example, the wind distribution panel can be spaced apart from the second side of the solar module by at least 5 mm to define the plenum, such as by at least 10 mm, such as spaced apart by a distance ranging from 5 mm to 50 mm (e.g., 5 mm to 25 mm).

In a further embodiment of this apparatus, the wind distribution panel further includes a first deflection extension that extends out from a first end of the wind distribution panel and extends out beyond the solar module. The first plane can be parallel to the second plane, and the first deflection extension can be at least partially outside of the second plane. In a further embodiment of this apparatus, the wind distribution panel can further include a second deflection extension that extends out from a second end of the wind distribution panel and extends out beyond the solar module. The second end of the wind distribution panel can be opposite the first end of the wind distribution panel. The second deflection extension can be at least partially outside of the second plane. In some instances, the first deflection extension and the second deflection extension can be symmetrical about the wind distribution panel.

In a further embodiment of this apparatus, the solar module is a first solar module, and the apparatus further includes a second solar module, an actuator system (e.g., including one or more of an actuator (e.g., linear actuator), a worm gear, a slew gear, etc.) and a wind cover. The second solar module is coupled to the torque tube that is configured to rotatably move the second solar module. The actuator system is coupled (e.g., rotatably coupled) to the torque tube. A first space is defined between the first solar module and a first side of the actuator system, and a second space is defined between the second solar module and a second opposite side of the actuator system. The wind cover extends from the first solar module, along the first space, along the second space, and to the second solar module.

Another embodiment includes a solar module apparatus. This solar module apparatus includes a solar module and a wind distribution panel. The solar module has a first side that includes a plurality of photovoltaic cells and a second side that is opposite the first side. The solar module has a solar module length and a solar module width, with the solar module length and the solar module width laying in a first plane. The wind distribution panel is spaced apart from the second side of the solar module to define a plenum between the wind distribution panel and the second side of the solar module. The wind distribution panel has a wind distribution panel length and a wind distribution panel width, with the wind distribution panel length and the wind distribution panel width laying in a second plane that is different than the first plane.

In a further embodiment of this apparatus, the first plane is parallel to the second plane. In one such further embodiment, at least one of: the wind distribution panel length is equal to or greater than the solar module length and the wind distribution panel width is equal to or greater than the solar module width.

In various embodiments of this apparatus, the wind distribution panel can be configured to direct wind into the plenum to reduce a magnitude of a wind-induced pressure load at the solar module.

In a further embodiment of this apparatus, the wind distribution panel further includes a first deflection extension and a second deflection extension. The first deflection extension extends out from a first end of the wind distribution panel and extends out beyond the solar module. The second deflection extension extends out from a second end of the wind distribution panel and extends out beyond the solar module. The second end of the wind distribution panel is opposite the first end of the wind distribution panel. In one such further embodiment, the first plane is parallel to the second plane, and each of the first deflection extension and the second deflection extension is at least partially outside of the second plane. The first deflection extension and the second deflection extension can be symmetrical about the wind distribution panel. In certain embodiments, each of the first deflection extension and the second deflection extension can extend out from the wind distribution panel at an angle, relative to the wind distribution panel, ranging from 10 degrees to 45 degrees.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is a perspective view of an embodiment of a solar module tracking apparatus.

FIG. 2 is a schematic side elevational view of wind loads experienced by a solar module without an associated wind distribution panel.

FIG. 3 is a schematic side elevational view of dynamic wind loads experienced by a solar module apparatus that includes a wind distribution panel associated with the solar module. FIG. 3 illustrates the wind loads applied at a front direction at the solar module apparatus.

FIG. 4 is a schematic side elevational view of dynamic wind loads experienced by the solar module apparatus of FIG. 3 by with the wind load illustrated as applied at a back direction at the solar module apparatus.

FIG. 5 is a schematic top plan view of another embodiment of a solar module tracking apparatus that includes both non-power generating, wind load reduction modules and solar modules.

FIGS. 6A and 6B illustrate another embodiment of a solar module tracking apparatus that includes a wind cover extending between solar modules. FIG. 6A is a schematic top plan view of a first embodiment of a solar module tracking apparatus that includes a wind cover extending between solar modules, and FIG. 6B is a schematic top plan view of a second embodiment of a solar module tracking apparatus that includes a wind cover extending between solar modules.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Embodiments disclosed herein include various devices, systems, and methods configured to help reduce a magnitude of wind loading applied at one or more solar modules. Embodiments disclosed herein can be configured to facilitate a net reduction in wind loading at a solar module, for instance, by incorporating one or more components that can reduce at least one of a positive wind load pressure and a negative wind load pressure on a solar module to thereby help to reduce the overall magnitude of wind load pressure at the solar module. For example, embodiments disclosed herein can incorporate a wind distribution panel adjacent a solar module to help reduce a negative/suction wind load pressure at the solar module. The wind distribution panel can be spaced apart from the solar module to define a plenum between the wind distribution panel and the second side of the solar module. For instance, the solar module can lay in a first plane, and the wind distribution panel can lay in a second plane that is parallel to the first plane, with the plenum defined between these first and second planes. The wind distribution panel can be configured to direct wind from a leading edge of the solar module, and/or wind distribution panel, into the plenum to thereby cause a reduction in a negative/suction wind load pressure at the solar module which in turn can reduce a net wind loading at the solar module.

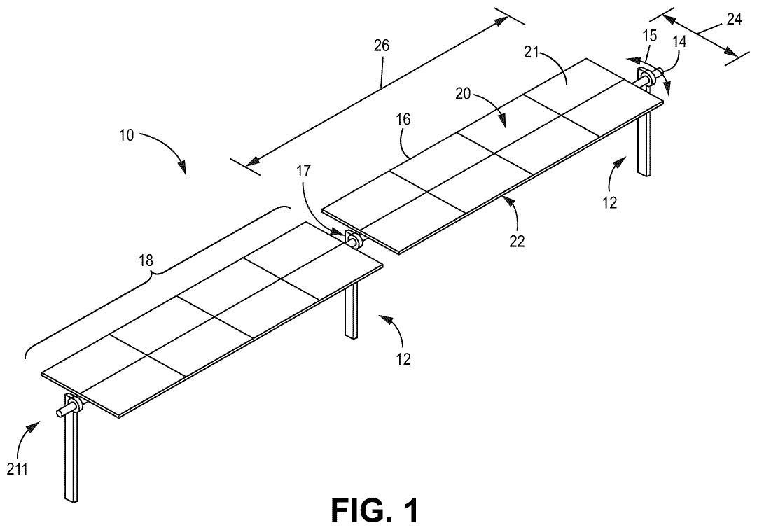

FIG. 1 illustrates a perspective view of an embodiment of a solar module tracking apparatus 10. The solar tracker apparatus 10 can include a plurality of piers 12 disposed in spaced relation to one another and embedded in the earth. The solar tracker apparatus 10 can include one or more torque tubes 14 that can extend between adjacent piers 12 and be rotatably supported at each pier 12. The solar tracker apparatus 10 can further include a plurality of solar modules 16 (e.g., solar panels having photovoltaic cells) supported at the respective torque tube 14. The one or more torque tubes 14 can be configured to rotatably move the solar modules 16, and, as such, the one or more torque tubes 14 can be rotated in directions 15 so as to change an angle of the solar modules 16 (e.g., throughout a day as the location of the sun changes relative to the solar modules 16). An actuator system (e.g., bearing housing assembly, slew drive/worm gear, etc.) 17 can be configured to support the torque tube 14 at the piers 12. In the case of a bearing housing assembly, the bearing house assembly can rotatably connect torque tubes 14 along a span of the solar tracker apparatus 10 at the piers 12. In the case of an actuator system 17 that includes a worm gear, the worm gear can rotatably support a single torque tube 14 at the piers 12. The span between two adjacent piers 12 is referred to as a bay 18 and, for example, in certain applications may be generally in the range of about 8 meters in length. A plurality of solar tracker apparatuses 10 may be arranged in a north-south longitudinal orientation to form a solar array configured to convert sunlight into electrical energy.

Each solar module 16 can have a first side 20 and a second side 22 that is opposite the first side 20. The first side 20 can include a plurality of photovoltaic cells 21 that are configured to generate electrical energy in response to sunlight irradiance. Each solar module 16 can have a solar module length 24 and a solar module width 26. The solar module length 24 and the solar module width 26 can lay in a first plane. For example, the solar module length 24 and the solar module width 26 can define the first plane within which the solar module length 24 and the solar module width 26 lay.

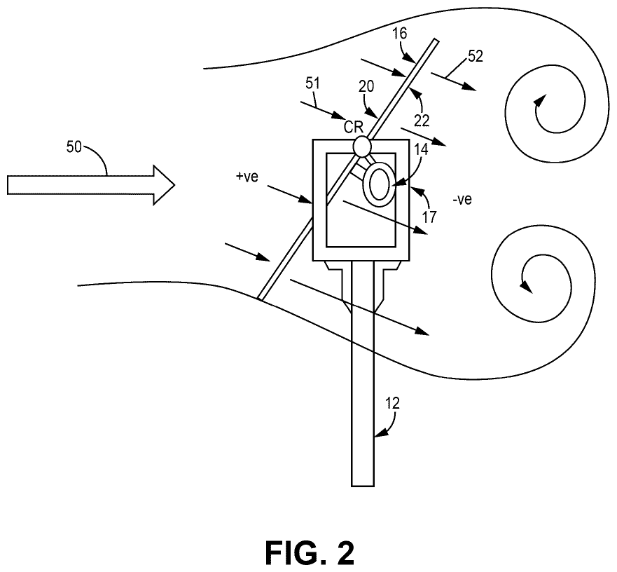

When installed in the field, the solar module tracking apparatus 10 can be subjected to dynamic wind loads. FIG. 2 shows a schematic side elevational view of wind loads experienced by a typical solar module 16 (e.g., without an associated wind distribution panel) installed in the field.

FIG. 2 illustrates solar module 16 subjected to wind load 50. When wind load 50 is applied to the solar module 16, wind load 50 can cause both positive pressure force components 51 (+Ve) and negative pressure force components 52 (−Ve). The magnitude of wind-induced pressure load at the solar module 16 can be equal to the magnitude of the positive pressure force components 51 (e.g., absolute value of summed+Ve components) and negative pressure force components 52 (e.g., absolute value of summed−Ve components). For the example shown at FIG. 2, wind load 50 is applied in a direction toward the first side 20 of the solar module 16. This direction of wind loading generally results in positive pressure force components 51 (+Ve) applied at the first side 20 and negative force components 52 (−Ve) applied at the second side 22. With the solar module 16 in the given rotational position shown at FIG. 2 as a result of torque tube 14 rotation, the positive pressure force components 51 applied at the first side 20 impart forces that push on the solar module 16 in a direction toward the ground surface. In addition, with the solar module 16 in the given rotational position shown at FIG. 2 as a result of torque tube 14 rotation, the negative pressure force components 52 applied at the second side 22 impart forces that pull on the solar module 16 in a direction toward the ground surface. Thus, in FIG. 2, the solar module 16 is subjected to a magnitude of a wind-induced pressure load in a direction toward the ground surface that is the total of both the absolute value of the positive pressure force components 51 and the absolute value of the negative force components 52.

Thus, as FIG. 2 demonstrates, solar tracking systems can be exposed to dynamic wind loads in the field. And the magnitude of such wind loads can depend on the orientation of the solar modules at the time of wind loading. The magnitude of such wind loads can be significant, particularly at certain rotational orientations of the solar modules and, accordingly, without an appropriate mechanism to help alleviate relatively high magnitude wind loading, solar tracking systems and the associated solar modules can be significantly damaged or destroyed. While it is possible ins some instances to alleviate dynamic wind loading by reorienting solar modules at the tracker to reduce the magnitude of wind loading on the solar modules, such reorienting can result in the solar modules being moved out of the intended, optimized energy generation position at that time and yet to only help alleviate what can be a temporary, dynamic degree of wind loading.

To help reduce a wind loading magnitude at one or more solar modules, certain embodiments disclosed herein can be configured to facilitate a net reduction in wind loading at a solar module, for instance, by incorporating one or more components that can reduce at least one of a positive wind load pressure and a negative wind load pressure on a solar module to, thereby, help to reduce the overall magnitude of wind load pressure at the solar module. For example, certain embodiments disclosed herein can incorporate a wind distribution panel adjacent a solar module to help reduce at least one of a negative/suction wind load pressure at the solar module and a positive/pushing wind load pressure at the solar module.

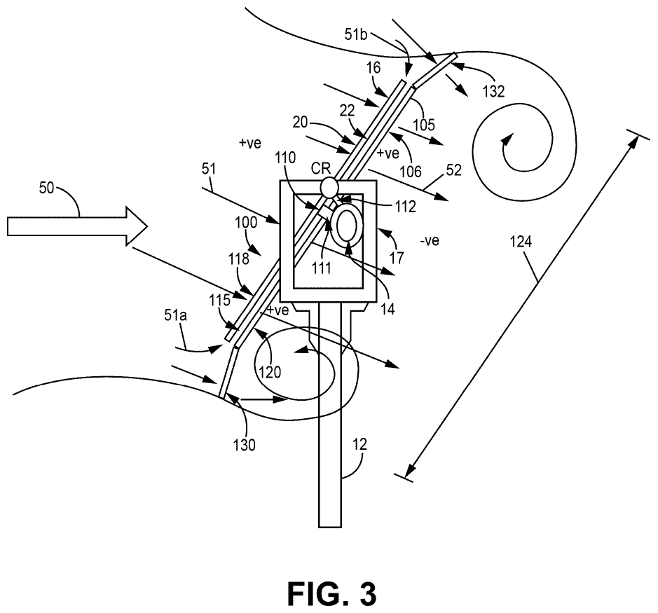

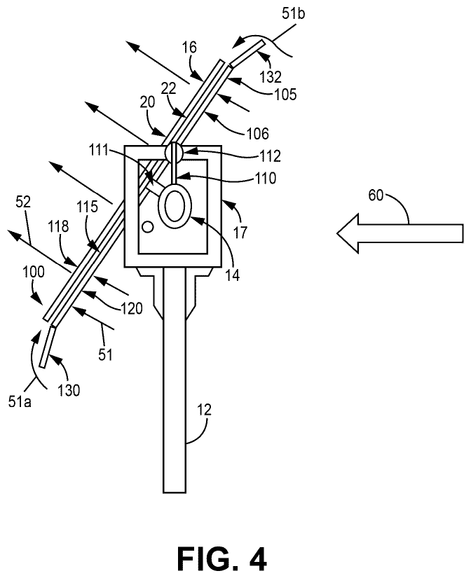

FIGS. 3 and 4 illustrate a schematic side elevational views of a solar module apparatus 100 that includes a wind distribution panel 105 associated with the solar module 16. FIG. 3 shows the solar module apparatus 100 subjected to a wind load 50 applied at a front direction at the solar module apparatus 100, and FIG. 4 shows the solar module apparatus 100 subjected to a wind load 60 applied at a back direction at the solar module apparatus 100. The solar module apparatus 100, incorporating the wind distribution panel 105, can be configured to help facilitate a net reduction in wind loading by, for instance, helping to reduce at least one of a positive wind load pressure and a negative wind load pressure on solar module apparatus 100 to, thereby, help to reduce the overall magnitude of wind load pressure at the solar module apparatus 100. As one example, the wind distribution panel 105 can be configured to help mitigate air flow separation at a leading surface of the solar module apparatus 100.

The solar module apparatus 100 can include the solar module 16 and the wind distribution panel 105, and the solar module apparatus 100 can be coupled to the torque tube 14. As such, the torque tube 14 can be configured to rotatably move the solar module 16 and the wind distribution panel 105. For example, a connection apparatus 110 can be configured to couple the solar module apparatus 100 to the torque tube 14. In one such embodiment, the connection apparatus 110 can include a solar module connecting member 111 that is configured to couple the solar module 16 to the torque tube 14 and a wind distribution connecting member 112 that is configured to couple the wind distribution panel 105 to the torque tube 14. This can be one example of independent connections between the solar module 16 and the torque tube 14 and the wind distribution panel 105 and the torque tube 14. Other independent connection configurations are within the scope of this disclosure as are connection configurations that couple, collectively, the solar module 16 and the wind distribution panel 105 to the torque tube 14.

The wind distribution panel 105 can be positioned adjacent to the solar module 16. For example, the wind distribution panel 105 can be positioned adjacent to the solar module 16 but spaced from the solar module 16. In the illustrated embodiments at FIGS. 3 and 4, the wind distribution panel 105 is positioned adjacent to the solar module 16 but spaced apart from the second side 22 of the solar module 16 to define a plenum 115 between the wind distribution panel 105 and the second side 22 of the solar module 16. As will be described further herein, the wind distribution panel 105 can be configured to direct wind (e.g., from wind load 50) into the plenum 115 to help reduce a magnitude of a wind-induced pressure load at the solar module.

The wind distribution panel 105 can have a variety of dimensions. The wind distribution panel 105 can have a wind distribution panel length 124 (e.g., in the same direction as the solar module length 24) and a wind distribution panel width 126 (e.g., in the same direction as the solar module width 26). In some embodiments, dimension(s) of the wind distribution panel 105 can match or exceed corresponding dimension(s) of the solar module 16. The wind distribution panel length 124 can be equal to or greater than the solar module length 24 and/or the wind distribution panel width 126 can be equal to or greater than the solar module width 26. The wind distribution panel 105 can define a wind distribution panel interior area 106 that is bounded by the wind distribution panel length 124 and the wind distribution panel width 126. The wind distribution panel interior area 106 can be equal to or greater than a solar module interior area that is defined by the solar module length 24 and the solar module width 26. Thus, in some embodiments, the solar module interior area can be at least coextensive with the wind distribution panel interior area 106.

The wind distribution panel 105 can have a variety of material makeups and structural configurations. For example, the wind distribution panel 105 can be generally flat at both of its longitudinal sides. As another additional or alternative example, the wind distribution panel 105 can be non-porous. For instance, the wind distribution panel interior area 106 can be non-porous. The wind distribution panel 105 can, for example, be made of steel, one or more polymers, fiber composite material(s), or glass as illustrative, non-limiting examples.

The wind distribution panel length 124 and the wind distribution panel width 126 can lay in a second plane 120, and this second plane be a different plane than the first plane 118 within which the solar module 16 lies. For example, the wind distribution panel length 124 and the wind distribution panel width 126 can define the second plane 120, and this second plane 120 can be a different plane than the first plane 118 within which the solar module 16 lies. In some embodiments, the first plane 118, within which the solar module 16 lies, and the second plane 120, within which the wind distribution panel 105 lies, can be different planes that overlap at in part or different planes that are parallel to one another. The illustrated example shows the first plane 118 parallel to the second plane 120. For such an example, the first plane 118 can be parallel to the second plane 120 at all rotational positions of the torque tube 14. As such, in this illustrated example, the wind distribution panel 105 can be positioned adjacent to the solar module 16, with the wind distribution panel 105 laying at least in part in the second plane 120 and the solar module 16 laying in the first plane, but with the wind distribution panel 105 spaced apart from the second side 22 of the solar module 16 to define the plenum 115 between the wind distribution panel 105 and the second side 22 of the solar module 16. The wind distribution panel can be spaced apart from the second side 22 of the solar module 16 by at least 5 mm, by at least 10 mm, by at least 15 mm, by at least 25 mm, or by at least 50 mm to define the plenum 115.

When the solar module apparatus 100 is installed in the field at a solar module tracking apparatus, such as the solar module tracking apparatus 10 shown at the example of FIG. 1, the solar module apparatus 100 can be configured to help facilitate a net reduction in wind loading by, for instance, helping to reduce at least one of a positive wind load pressure and a negative wind load pressure on solar module apparatus 100 to, thereby, help reduce the overall magnitude of wind load pressure at the solar module apparatus 100.

As noted, FIG. 3 illustrates wind load 50 applied at a front direction at the solar module apparatus 100. In this example, the applied wind load 50 results in both positive pressure force components 51 (+Ve) and negative pressure force components 52 (−Ve) being applied at the solar module apparatus 100. The wind distribution panel 105 can be configured to direct at least some of wind load 50 into the plenum 115 to help reduce a magnitude of a wind-induced pressure load at the solar module 100. For instance, as wind load 50 is applied at the front direction at the solar module apparatus 100, the wind distribution panel 105 and resulting plenum 115 can act to direct peripheral portions 51a, 51b of the wind load 50 into the plenum 115 thereby acting to help mitigate flow separation at the leading surface of the solar module apparatus 100 which in turn can help to decrease the magnitude of the negative pressure force components 52 acting as a suction force on the back side of the solar module apparatus 100. Namely, as wind load 50 is applied at the front direction at the solar module apparatus 100, the wind distribution panel 105 and resulting plenum 115 can act to direct peripheral portion 51a of the wind load 50 into the plenum 115 from a bottom side of the plenum 115 and act to direct peripheral portion 51b of the wind load 50 into the plenum 115 from a top side of the plenum 115. This ability of the wind distribution panel 105 to act to direct portions of the wind load 50 into the plenum 115 can result in a reduced magnitude of negative pressure force components 52 (−Ve) acting on the solar module apparatus 100 which in turn can cause a reduction in the overall magnitude of a wind-induced pressure load at the solar module apparatus 100 caused by the wind load 50.

FIG. 4 illustrates wind load 60 applied at a back direction at the solar module apparatus 100, and shows how the wind distribution panel 105 and plenum 115 can act to reduce the overall magnitude of a wind-induced pressure load at the solar module apparatus 100 similar to that described above for FIG. 3 but now applied to the wind load 60 at the back direction as shown at FIG. 4. The wind distribution panel 105 can be configured to direct at least some of wind load 60 into the plenum 115 to help reduce a magnitude of a wind-induced pressure load at the solar module 100. For instance, as wind load 60 is applied at the back direction at the solar module apparatus 100, the wind distribution panel 105 and resulting plenum 115 can act to direct peripheral portions 51a, 51b of the wind load 60 into the plenum 115 thereby acting to help mitigate flow separation at the trailing surface of the solar module apparatus 100 which in turn can help to decrease the magnitude of the negative pressure force components 52 acting as a suction force on the front side of the solar module apparatus 100. Namely, as wind load 60 is applied at the back direction at the solar module apparatus 100, the wind distribution panel 105 and resulting plenum 115 can act to direct peripheral portion 51a of the wind load 60 into the plenum 115 from a bottom side of the plenum 115 and act to direct peripheral portion 51b of the wind load 60 into the plenum 115 from a top side of the plenum 115. This ability of the wind distribution panel 105 to act to direct portions of the wind load 60 into the plenum 115 can result in a reduced magnitude of negative pressure force components 52 (−Ve) acting on the solar module apparatus 100 which in turn can cause a reduction in the overall magnitude of a wind-induced pressure load at the solar module apparatus 100 caused by the wind load 60.

In some embodiments, such as that illustrated, the wind distribution panel 105 can include one or more deflection extensions 130, 132. The one or more deflection extensions 130, 132 can extend out from the wind distribution panel 105. For example, the one or more deflection extensions 130, 132 can extend out from the wind distribution panel 105 at least in a direction of the wind distribution panel length 124. The exemplary embodiment of the illustrated wind distribution panel 105 includes a first deflection extension 130 and a second deflection extension 132. The first deflection extension 130 can extend out from a first end (e.g., bottom end) of the wind distribution panel 105. For instance, the first deflection extension 130 can extend out from the wind distribution panel 105 beyond the solar module 16 at that first end of the wind distribution panel 105. The second deflection extension 132 can extend out from a second end (e.g., opposite the first end, such as a top end opposite the first/bottom end) of the wind distribution panel 105. For instance, the second deflection extension 132 can extend out from the wind distribution panel 105 beyond the solar module 16 at that second end of the wind distribution panel 105. Thus, the illustrated embodiment of the wind distribution panel 105 includes deflection extensions 130, 132 at opposite sides of the wind distribution panel 105.

As also shown for the illustrated embodiment of the wind distribution panel 105, the one or more deflection extensions 130, 132 can extend out from the wind distribution panel 105 at a skewed orientation relative to the main body of the wind distribution panel 105. For example, at a location where one or more deflection extensions 130, 132 extend out from the wind distribution panel 105 beyond the solar module 16, the one or more deflection extensions 130, 132 can be skewed relative to the main body of the wind distribution panel 105 and/or the solar module 16. As one such example, each of the first deflection extension 130 and the second deflection extension 132 can extend out from the wind distribution panel 105 at an angle, relative to the wind distribution panel 105, ranging from 5 degrees to 85 degrees, from 10 degrees to 65 degrees, from 10 degrees to 45 degrees, from 10 degrees to 35 degrees, or from 15 to 25 degrees. In instances where one or more deflection extensions 130, 132 extend out from the wind distribution panel 105 at a skewed orientation relative to the main body of the wind distribution panel 105, the main body of the wind distribution panel 105 can be parallel to the solar module 16 while such one or more deflection extensions 130, 132 can be non-parallel to the solar module 16. For instance, the first plane 118, within which the solar module 16 lays, can be parallel to the second plane 120, within which the main body of the wind distribution panel 105 lays, and the first deflection extension 130 can be at least partially outside of the second plane 120. In one particular such instance, the first deflection extension 130 can at least partially be outside of the second plane 120 and intersect the first plane 118. Similarly, when so included, the second deflection extension 132 can be at least partially outside of the second plane 120. In one particular such instance, the second deflection extension 132 can at least partially be outside of the second plane 120 and intersect the first plane 118. For embodiments that include two or more deflection extensions 130, 132, the deflection extensions 130, 132 can be symmetrical to one another or asymmetrical to one another. The illustrated embodiment shows the first and second deflection extensions 130, 132 as generally asymmetrical about the wind distribution panel 105 with the second deflection extension 132 at the top side having a greater angular offset from the wind distribution panel 105 than the first deflection extension 130 at the bottom side, though in other embodiments the first and second deflection extensions 130, 132 can be generally symmetrical about the wind distribution panel 105.

The one or more deflection extensions 130, 132 can have a variety of material makeups and structural configurations. For example, the one or more deflection extensions 130, 132 can be generally planar components or can include curvature, such as at a distal end portion—opposite a proximal end portion adjacent the wind distribution panel 105 main body—of the one or more deflection extensions 130, 132. As another example, the one or more deflection extensions 130, 132 can be non-porous or the one or more deflection extensions 130, 132 can include a plurality of pores along a length extending beyond the solar module 16 through which at least some wind load can pass therethrough. The one or more deflection extensions 130, 132 can, for example, be made of steel, one or more polymers, fiber composite material(s), or glass as illustrative, non-limiting examples.

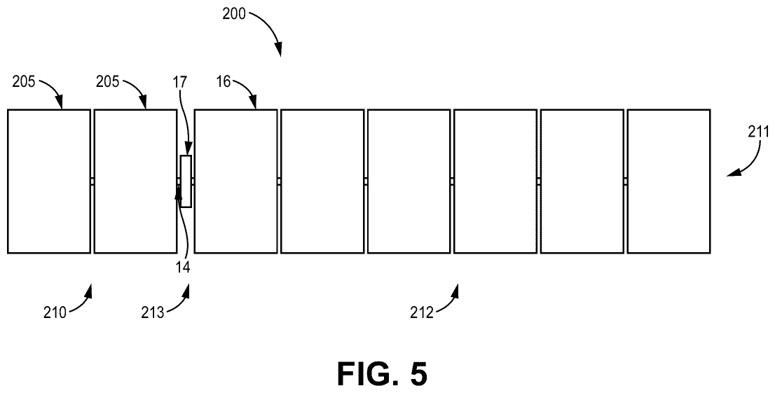

FIG. 5 illustrates another embodiment that can be useful in solar tracking applications to help reduce a magnitude of wind-induced pressure load. FIG. 5 shows a schematic top plan view of an embodiment of a solar module tracking apparatus 200 that includes both non-power generating, wind load reduction modules 205 and solar modules 16. The solar module tracking apparatus 200 can, in some embodiments, in addition to the details described and illustrated with respect to FIG. 5, also include the wind distribution panel and associated plenum described previously herein. Thus, in some embodiments, the details described and illustrated with respect to FIG. 5 can be in addition to the details of the solar module apparatus 100 (e.g., including the wind distribution panel 105 and associated plenum 115) described and illustrated previously herein. In other embodiments the solar module tracking apparatus 200 of FIG. 5 can be an alternative to using the solar module apparatus 100 (e.g., including the wind distribution panel 105 and associated plenum 115) described and illustrated previously herein.

The solar module tracking apparatus 200 can include both non-power generating, wind load reduction modules 205 and solar modules 16. The solar modules 16 can include photovoltaic cells and can be configured to generate electrical power from sunlight, as described previously herein. Whereas, on the other hand, the wind load reduction modules 205 can be “dummy” modules that are not able to generate electrical power from sunlight (e.g., lack photovoltaic cells). The non-power generating, wind load reduction modules 205 can be equal to or greater in size than the solar modules 16 (e.g., a non-power generating, wind load reduction module length can be equal or greater than the solar module length 24; and/or a non-power generating, wind load reduction module width can be equal or greater than the solar module width 26). In one or more regions of the solar module tracking apparatus 200 subjected to relatively high wind loading (e.g., variable, dynamic wind loading), the solar module tracking apparatus 200 can replace some solar modules 16 with the non-power generating, wind load reduction modules 205.

As one example, an end 210 of a row 211 of the solar module tracking apparatus 200 may be subjected to higher wind loading than a more central location 212 along that same row 211 of the solar module tracking apparatus 200. As such, the solar module tracking apparatus 200 can include one or more non-power generating, wind load reduction modules 205 at the end 210 of the row 211. The illustrated embodiment of the solar module tracking apparatus 200 includes at least two non-power generating, wind load reduction modules 205 at the end 210 of the row 211 (e.g., and adjacent bearing housing assembly 17). In a further embodiment, at an opposite end of the row 211 not shown, the solar module tracking apparatus 200 can similarly include one or more non-power generating, wind load reduction modules 205 at this other, opposite end of the row 211 such that the row 211 includes one or more non-power generating, wind load reduction modules 205 at each, opposite end of the row 211. This can help to reduce wind loading applied at the ends of a given row of a solar tracker, which can be the locations typically subject to higher relative wind loads.

As another example, locations 213 along the row 211 where spacing between solar modules 16 is greater than or equal to one meter, a solar module 16 that would otherwise be spaced equal to or more than one meter for an adjacent solar module 16 can be replaced with the non-power generating, wind load reduction module 205. For example, the solar module tracking apparatus 200 includes bearing housing assembly 17 to rotatably support torque tube 14. As a result of the presence of bearing housing assembly 17 at row location 213 (e.g., a relatively central region along the row 211), solar module 16 would otherwise be spaced equal to or more than one meter from a solar module that would be coupled to the other side of the bearing housing assembly 17. As such, at the location 213 where the spacing between modules is equal to or greater than one meter, the solar module tracking apparatus 200 uses the non-power generating, wind load reduction module 205 at the other side of the bearing housing assembly 17.

Incorporating one or more non-power generating, wind load reduction modules 205 at the solar module tracking apparatus 200 can be helpful in reducing a magnitude of wind load applied at solar modules 16 of the solar module tracking apparatus 200. For example, a wind load tolerance of the solar module tracking apparatus 200 can be improved by using one or more non-power generating, wind load reduction modules 205 adjacent one or more solar modules 16 at one or more locations along a row of the tracking apparatus subjected to relatively higher wind loading.

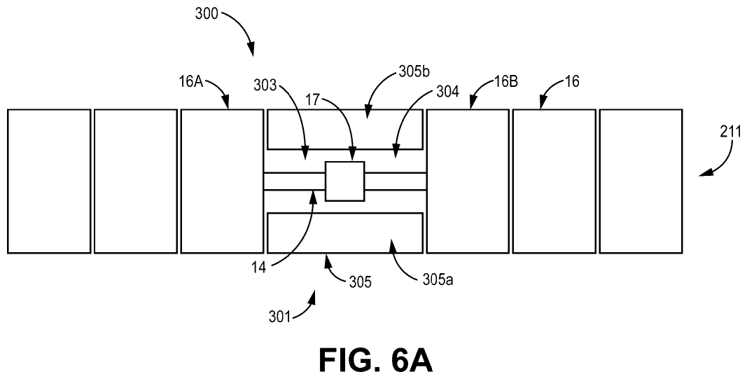

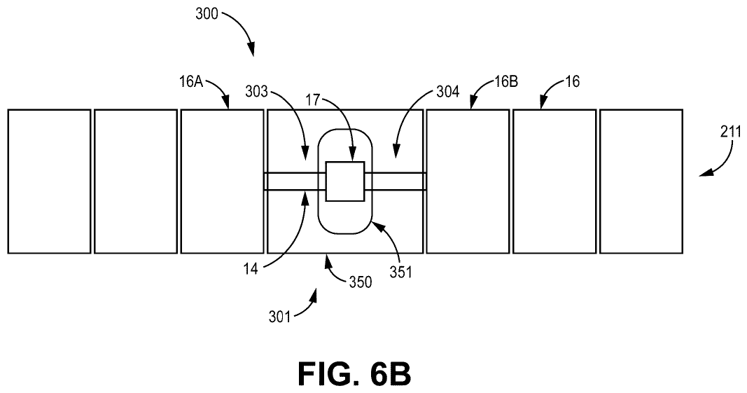

FIGS. 6A and 6B illustrate a further embodiment that can be useful in solar tracking applications to help reduce a magnitude of wind-induced pressure load. FIGS. 6A and 6B illustrate another embodiment of a solar module tracking apparatus 300 that includes a wind cover extending between solar modules. FIG. 6A is a schematic top plan view of a first embodiment of the solar module tracking apparatus 300 that includes a wind cover 305 extending between solar modules 16, and FIG. 6B is a schematic top plan view of a second embodiment of a solar module tracking apparatus 300 that includes a wind cover 350 extending between solar modules 16. The solar module tracking apparatus 300 can, in some embodiments, in addition to the details described and illustrated with respect to FIGS. 6A and 6B, also include the wind distribution panel and associated plenum described previously herein. Thus, in some embodiments, the details described and illustrated with respect to FIGS. 6A and 6B can be in addition to the details of the solar module apparatus 100 (e.g., including the wind distribution panel 105 and associated plenum 115) described and illustrated previously herein. In other embodiments the solar module tracking apparatus 300 of FIGS. 6A and 6B can be an alternative to using the solar module apparatus 100 (e.g., including the wind distribution panel 105 and associated plenum 115) described and illustrated previously herein. Similarly, the solar module tracking apparatus 300 can, in some embodiments, in addition to the details described and illustrated with respect to FIGS. 6A and 6B (e.g., and in addition to the details of the solar module apparatus 100 (e.g., including the wind distribution panel 105 and associated plenum 115) described and illustrated previously herein), also include one or more non-power generating, wind load reduction modules as described for the solar module tracking apparatus 200 of FIG. 5. In other embodiments the solar module tracking apparatus 300 of FIGS. 6A and 6B can be used with just one or neither of the solar module apparatus 100 (e.g., including the wind distribution panel 105 and associated plenum 115) and non-power generating, wind load reduction modules described and illustrated previously herein.

Referring to FIG. 6A, the solar module tracking apparatus 300 can include a wind cover 305 extending between solar modules 16. The solar module tracking apparatus 300 includes solar modules 16 rotatably coupled to torque tube 14 and defining row 211. Actuator system 17 is rotatably coupled to torque tube 14 between solar modules 16 at location 301. A first space 303 is defined between first solar module 16A and a first side of the actuator system 17, and a second space 304 is defined between second solar module 16B and a second, opposite side of the actuator system 17. The wind cover 305 extends from the first solar module 16A, along the first space 303, along the second space 304, and to the second solar module 16B. In particular, the illustrated embodiment of the wind cover 305 at FIG. 6A incudes a first wind cover member 305a and a second wind cover member 305b. The first wind cover member 305a extends from the first solar module 16A, along the first space 303, along the second space 304, and to the second solar module 16B. Likewise, the second wind cover member 305b extends from the first solar module 16A, along the first space 303, along the second space 304, and to the second solar module 16B. In the illustrated embodiment, the first and second wind cover members 305a, 305b are spaced apart from one another about the actuator system 17 with the first wind cover member 305a extending along and past a first side of the actuator system 17 and the second wind cover member 305b extending along and past a second, opposite side of the actuator system 17. In one example, the first and second wind cover members 305a, 305b can extend along the space between solar modules 16 at the noted actuator system (e.g., bearing housing assembly or worm gear, etc.) space location 301 with the first and second wind cover members 305a, 305b on opposite sides of this space location 301. For instance, one of the first and second wind cover members 305a, 305b can be on an east side of the space location 301 whereas the other of the first and second wind cover members 305a, 305b can be on a west side of the space location 301. The wind cover 305, with the first and second wind cover members 305a, 305b extending along the actuator system (e.g., bearing housing assembly) spacing between solar modules 16, can help to cover space between solar modules 16 and thereby provide wind mitigation shielding to reduce net wind pressure loading at solar module(s) 16 adjacent the wind cover 305 of the solar module tracking apparatus 300.

Referring to FIG. 6B, the solar module tracking apparatus 300 can include a wind cover 350 extending between solar modules 16. As described in reference to FIG. 6A, the first space 303 is defined between first solar module 16A and a first side of the actuator system 17, and a second space 304 is defined between second solar module 16B and a second, opposite side of the actuator system 17. The wind cover 350 extends from the first solar module 16A, along the first space 303, along the second space 304, and to the second solar module 16B. The wind cover 350 can be positioned between the solar module 16A, 16B at locations that shield and over space each of a top side, an opposite bottom side, a left side and an opposite right side at the location 301 of the actuator system (bearing housing assembly or worm gear, etc.) 17. The wind cover 350 includes an access opening 351, and the wind cover 350 is positioned to extend from the first solar module 16A, along the first space 303, along the second space 304, and to the second solar module 16B with the access opening 351 at least partially aligned with the actuator system 17. The wind cover 350, like the wind cover 305, can help to cover space between solar modules 16 and thereby provide wind mitigation shielding to reduce net wind pressure loading at solar module(s) 16 adjacent the wind cover 305 of the solar module tracking apparatus 300.

In addition to the various embodiments described previously herein, also within the scope of the present disclosure are various method embodiments that include installing and/or using any one or more of the features described herein and illustrated herewith.

Various examples have been described. These and other examples are within the scope of the following claims.

What is claimed is:

1. A solar module tracking apparatus comprising:
a solar module having a first side that includes a plurality of photovoltaic cells and a second side that is opposite the first side, the solar module having a solar module length and a solar module width, the solar module length and the solar module width laying in a first plane;
a wind distribution panel spaced apart from the second side of the solar module to define a plenum between the wind distribution panel and the second side of the solar module, the wind distribution panel having a wind distribution panel length and a wind distribution panel width, the wind distribution panel length and the wind distribution panel width laying in a second plane, the second plane being different than the first plane; and
a torque tube that is configured to rotatably move the solar module and the wind distribution panel.

2. The apparatus of claim 1, wherein the first plane is parallel to the second plane at all rotational positions of the torque tube.

3. The apparatus of claim 2, wherein the wind distribution panel length is equal to or greater than the solar module length.

4. The apparatus of claim 3, wherein the wind distribution panel width is equal to or greater than the solar module width.

5. The apparatus of claim 4, wherein the wind distribution panel defines a wind distribution panel interior area that is bounded by the wind distribution panel length and the wind distribution panel width, and wherein the wind distribution panel interior area is non-porous.

6. The apparatus of claim 2, wherein the wind distribution panel is configured to direct wind into the plenum to reduce a magnitude of a wind-induced pressure load at the solar module.

7. The apparatus of claim 6, wherein the wind distribution panel is spaced apart from the second side of the solar module by at least 5 mm to define the plenum.

8. The apparatus of claim 1, wherein the wind distribution panel further comprises a first deflection extension that extends out from a first end of the wind distribution panel and extends out beyond the solar module.

9. The apparatus of claim 8, wherein the first plane is parallel to the second plane, and wherein the first deflection extension is at least partially outside of the second plane.

10. The apparatus of claim 9, wherein the wind distribution panel further comprises a second deflection extension that extends out from a second end of the wind distribution panel and extends out beyond the solar module, the second end of the wind distribution panel being opposite the first end of the wind distribution panel.

11. The apparatus of claim 10, wherein the second deflection extension is at least partially outside of the second plane, and wherein the first deflection extension and the second deflection extension are symmetrical about the wind distribution panel.

12. The apparatus of claim 1, wherein the solar module is a first solar module, and further comprising:
a second solar module coupled to the torque tube that is configured to rotatably move the second solar module;
an actuator system coupled to the torque tube, wherein a first space is defined between the first solar module and a first side of the actuator system, and wherein a second space is defined between the second solar module and a second opposite side of the actuator system; and
a wind cover extending from the first solar module, along the first space, along the second space, and to the second solar module.

13. A solar module apparatus comprising:
a solar module having a first side that includes a plurality of photovoltaic cells and a second side that is opposite the first side, the solar module having a solar module length and a solar module width, the solar module length and the solar module width laying in a first plane; and
a wind distribution panel spaced apart from the second side of the solar module to define a plenum between the wind distribution panel and the second side of the solar module, the wind distribution panel having a wind distribution panel length and a wind distribution panel width, the wind distribution panel length and the wind distribution panel width laying in a second plane, the second plane being different than the first plane.

14. The apparatus of claim 13, wherein the first plane is parallel to the second plane.

15. The apparatus of claim 14, wherein at least one of: the wind distribution panel length is equal to or greater than the solar module length and the wind distribution panel width is equal to or greater than the solar module width.

16. The apparatus of claim 14, wherein the wind distribution panel is configured to direct wind into the plenum to reduce a magnitude of a wind-induced pressure load at the solar module.

17. The apparatus of claim 13, wherein the wind distribution panel further comprises a first deflection extension and a second deflection extension, the first deflection extension extending out from a first end of the wind distribution panel and extending out beyond the solar module, the second deflection extension extending out from a second end of the wind distribution panel and extending out beyond the solar module, the second end of the wind distribution panel being opposite the first end of the wind distribution panel.

18. The apparatus of claim 17, wherein the first plane is parallel to the second plane, and wherein each of the first deflection extension and the second deflection extension is at least partially outside of the second plane.

19. The apparatus of claim 18, wherein the first deflection extension and the second deflection extension are symmetrical about the wind distribution panel.

20. The apparatus of claim 18, wherein the each of the first deflection extension and the second deflection extension extend out from the wind distribution panel at an angle, relative to the wind distribution panel, ranging from 10 degrees to 45 degrees.
